(19) United States
(12) Patent Application Publication
(10) Pub. No.: US 2009/0013288 A1
(43) Pub. Date: Jan. 8, 2009

(54) Video Promotion for Online Directory Listings and Other Search Engine Websites that List Advertisers

(75) Inventor: Irit Scheflan, Township of Washington, NJ (US)

Correspondence Address: FOX ROTHSCHILD LLP;New York, 2000 Market Street, Tenth Floor, Philadelphia, PA, 19103, US

(73) Assignee: ONE ON ONE ADS, INC.

(21) Appl. No.: 12/167,027

(22) Filed: Jul. 2, 2008

Related U.S. Application Data
(60) Provisional application No. 60/948,148, filed on Jul. 5, 2007.

(51) Int. Cl. G06F 3/048

(52) U.S. Cl. 715/859

(57) ABSTRACT

A webpage file is transmitted to a client computer. The webpage file provides directory listings or search engine results, which are presented in the form of a list of hyperlinks. Each hyperlink corresponds to a directory listing entry or a search engine hit. In response to a pointer on the client computer hovering over a hyperlink in this list of hyperlinks, a video corresponding to the hyperlink is determined by correlating an advertiser with the hyperlink, such as by extracting the advertiser's ID number from the hyperlink, and by correlating within a video database each of a plurality of videos with a respective advertiser. A matching video is then transmitted to the client computer to cause the client computer to play the video in a window that floats over the original webpage.

### CROSS-REFERENCE TO RELATED APPLICATIONS

This application claims the benefit of U.S. Provisional Application 60/948,148 filed on Jul. 5, 2007, the teachings of which are incorporated herein by reference.

### FIELD OF THE INVENTION

The present invention relates generally to Internet advertising. More particularly, the present invention discloses a system and related method for displaying advertisement videos related to links on a web page.

### BACKGROUND OF THE INVENTION

The Internet (or World Wide Web) has become a significant research tool for consumers seeking information on products and services. Consequently, the Internet has also become a key advertising market. How to catch and hold the interest of web-browsing consumers is a major consideration for advertisers, and the ability of one advertiser to distinguish itself from the plethora of others may lead to greater ad revenues and sales.

Advertisers have employed any number of audio and/or visual techniques to attract the interest of consumers. For example, the use of hyperlinks within a webpage to display a video is known. The drawback to this commercial distribution method is that the user must actually click upon the hyperlink to cause the video player to launch and play the video. Although such a minor action would not appear to be an insurmountable viewing barrier, the reality is that many users are simply reluctant to click on hyperlinks unless they know the hyperlink will connect them to content that they genuinely want, and this is generally not the case with advertisements.

An alternative advertising method causes a window or bubble to appear when the mouse pointer hovers over a hyperlink. This window or bubble contains related text, and “floats” above the webpage containing the hyperlink. This method is advantageous as it does not require the user to actually click upon the hyperlink to cause the window or bubble to appear. However, text is not particularly engaging, and so is easily ignored by the user.

Accordingly, there is an immediate need for improved methods and systems for delivery of advertising content to users.

### SUMMARY OF THE INVENTION

The present invention overcomes the drawbacks of the prior art. The present invention discloses an advertising method that plays a video related to a hyperlink when the mouse pointer of the user hovers over the hyperlink in a webpage. The video is overlaid and played on the underlying webpage and thus does not disturb the performance or underlying appearance of the webpage.

Preferred embodiment methods provide for the delivery of videos to a client computer. A webpage file is transmitted to a client computer. The webpage file comprises directory listings or search engine results, which are presented in the form of a list of hyperlinks. Each hyperlink corresponds to a directory listing entry or a search engine hit in the list. In response to a pointer on the client computer hovering over a hyperlink in the list of hyperlinks, a first video corresponding to the hyperlink is determined. In various embodiments, such a determination is made by correlating an advertiser with the hyperlink, such as by extracting the advertiser's identification (ID) number from the hyperlink, and by correlating within a video database each of a plurality of videos with a respective advertiser. Matching video data transmitted to the client computer is then used to cause the client computer to play the video in a window that floats over the original webpage.

In some embodiments, an embedded application within the webpage file may cause the client computer to download all videos respectively associated with the list of hyperlinks. The client computer then plays the appropriate video when the pointer hovers over the corresponding hyperlink. In other embodiments, the embedded application requests the respective video data in response to the pointer hovering over the corresponding hyperlink and the resulting video data streaming into the client computer is played as a video. In preferred embodiments, the client computer stops playing the video when the pointer moves away from the hyperlink.

In specific embodiments the webpage contains an embedded application that is executable by the client computer. The embedded application monitors the position of the pointer to determine if the pointer is hovering over a hyperlink, obtains the advertiser-related information corresponding to a hyperlink, transmits advertiser-related information to a video server, and plays video data obtained from the video server.

In some embodiments, the scripting code also causes the client computer to display a logo in relation to each hyperlink that has a corresponding video. In specific embodiments, the logo is served by the server that provides the video data and is positioned as part of the video uploading when a match with the advertiser ID number is found.

### BRIEF DESCRIPTION OF THE DRAWINGS

FIG. 1 illustrates a system according to an embodiment method.

FIG. 2 illustrates an embodiment webpage file.

FIG. 3 is a flow chart according to one embodiment.

FIG. 4 illustrates an embodiment video server.

FIG. 5 illustrates another embodiment webpage file.

### DETAILED DESCRIPTION

For purposes of the following disclosure, the terms “program code,” “code,” “script,” “scripting code” or the like are intended to mean any machine readable set of logical instructions that causes a computer to perform certain specified tasks. Hence, program code may include, for example, machine language and assembly language. It is also intended to more broadly include, however, other logical languages, such as C++, the .NET framework, JavaScript, Flash, HTML and so forth. The terms “run,” execute,” “process” and the like are intended to mean that a computer processes the logical instructions present in code to perform the steps indicated by that code. Execution of code may be direct, as with machine code, or may be indirect, as with code that is interpreted (such as HTML), compiled (such as C++) or both (such as Java).

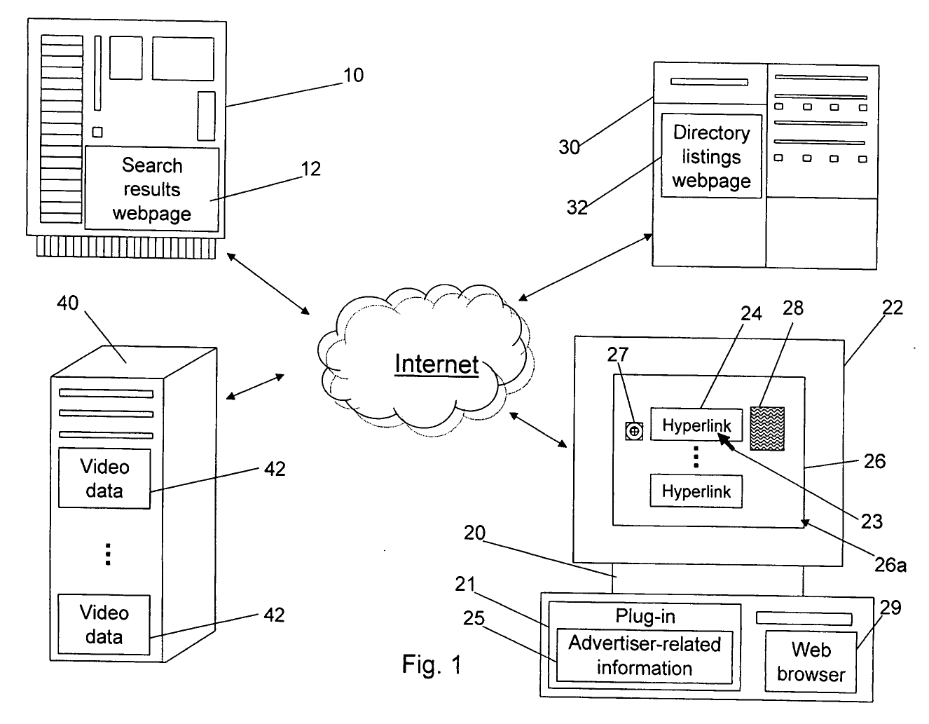

FIG. 1 illustrates a system capable of performing an embodiment advertising method. The system includes a search engine server 10, a directory listings server 30, a video data server 40 and a client computer 20, all of which are in communications with the Internet. The search engine server 10 receives a search request from the client computer 20 in a standard manner, typically in the form of one or more key words, and in response generates a search engine results webpage 12. Similarly, the directory listings server 30 may receive a directory listings request from the client computer 20, typically when the client clicks on a related hyperlink or enters a keyword, and in response generates a directory listings webpage 32.

Both the search engine results webpage 12 and the directory listings webpage 32, although presenting different types of information, are similar in form in that they present their respective types of information in textual form, typically as a sorted list; this results list (i.e., the search engine results or directory listings) may be sorted, for example, by a perceived relevance, as with the search engine server 10, or alphabetically, as with the directory listings server 30. In both cases, though, the sorted lists are in the form of hyperlinks, which present textual information to the user, and which may be clicked upon by the user of the client computer 20 for redirection to a related webpage, in a standard manner. Each webpage 12, 32 may be generated in a standard manner, but augmented as discussed below to support an embodiment advertising method.

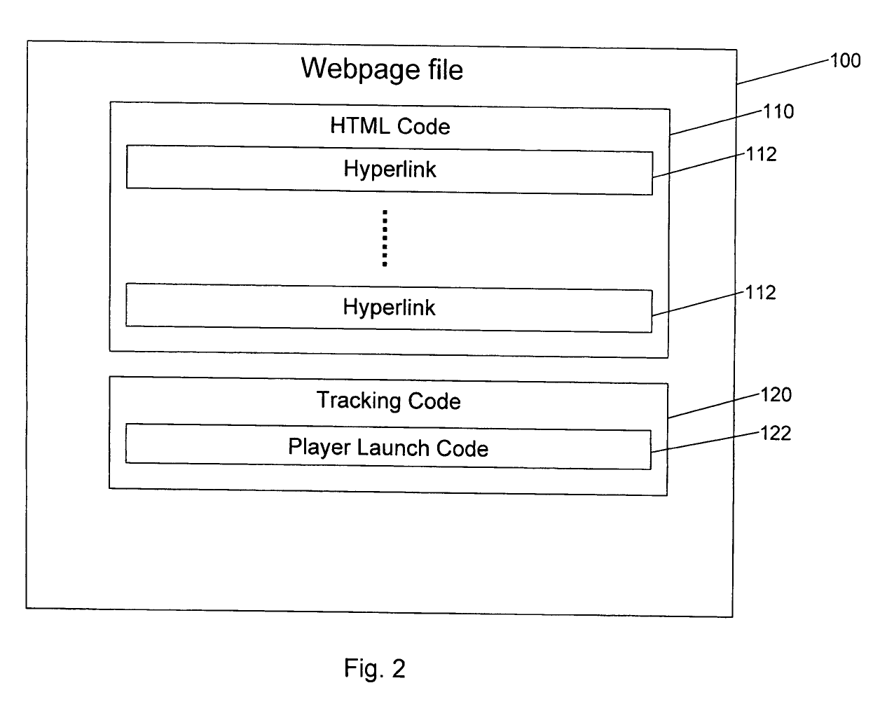

FIG. 2 illustrates an embodiment webpage file 100 that generally represents either one of the search engine results webpage 12 or the directory listings webpage 34. In response to a standard search request to the search engine 10, or a directory listings request to the directory listings server 30, from the client computer 20, the respective server 10, 30 generates the webpage file 100 and transmits the webpage file 100 to the client computer 20. The client computer 20 contains a web browser 29 that processes the webpage file 100 to display a corresponding webpage image 26a within a visual window 26 on a display 22 of the client computer 20, as known in the art. The webpage image 26a contains a plurality of hyperlinks 24 that each corresponds to a directory listing entry or a search engine hit as coded within the webpage file 100. Additionally, the webpage file 100 contains code that tracks a pointer 23 and causes the client computer 20 to play a related video 28 when the pointer hovers over a hyperlink 24. Hence, the search engine server 10 and the directory listings server 30 may each respectively augment a standard search results webpage 14 or directory listings webpage 32 by simply including the tracking code 120. The video 28 is overlaid on the webpage image 26a, and so does not interfere with the webpage image 26a.

In the embodiment webpage file 100, the webpage file 100 contains standard scripting code, such as HTML 110, that encodes the results list for the webpage image 26a on the end-user computer 20, and includes hyperlink code 112 that corresponds to the displayed hyperlinks 24. Each hyperlink 24 corresponds to a search engine hit, or a directory listing entry, depending upon which server 10, 30 provided the webpage file 100. A search engine hit may be, for example, a hyperlink 24 to another webpage that contains the keywords entered by the user of the client computer 20 when requesting a search. A directory listing entry may be a hyperlink 24 to the website of a product or service provider within the class of products or services that the user of the client computer 20 is interested in browsing within. The webpage file 100 also contains tracking code 120 that tracks the position of the pointer 23 and calls player launch code 122 when the pointer 23 hovers over a hyperlink 24. The player launch code 122 causes the client computer 20 to launch a video player and to play the video 28 that corresponds to the hyperlink 24 over which the pointer 23 is hovering. By way of example, the tracking code 120 could be JavaScript, Flash, or any other suitable programming language, or could be provided by various modules, each written in a respective coding language that can call other modules. As known in the art, each language may be supported by a corresponding plug-in 21 on the client computer 20 that processes the tracking code 120 according to the language type of the tracking code 120. In preferred embodiments the video player is installed on the client computer 20, and may be, for example, a Flash player.

It will be appreciated by those of reasonable skill that the tracking code 120 may, in various embodiments, simply be a reference to another file, which is then downloaded and processed by the plug-in 21. For example, the tracking code may be an HTML script that calls a JavaSript program. For purposes of the following, a reference to another file, such as described, that contains the code is considered equivalent to actually placing the code itself into the webpage file 100, and so for purposes of simplicity, the following disclosure treats the tracking code 120 as being within the same actual file 100. Either result, placing tracking code 120 into the webpage file 100 itself, or placing a reference to another file that contains the tracking code 120, both result in embedding the tracking code 120 into the webpage file 100.

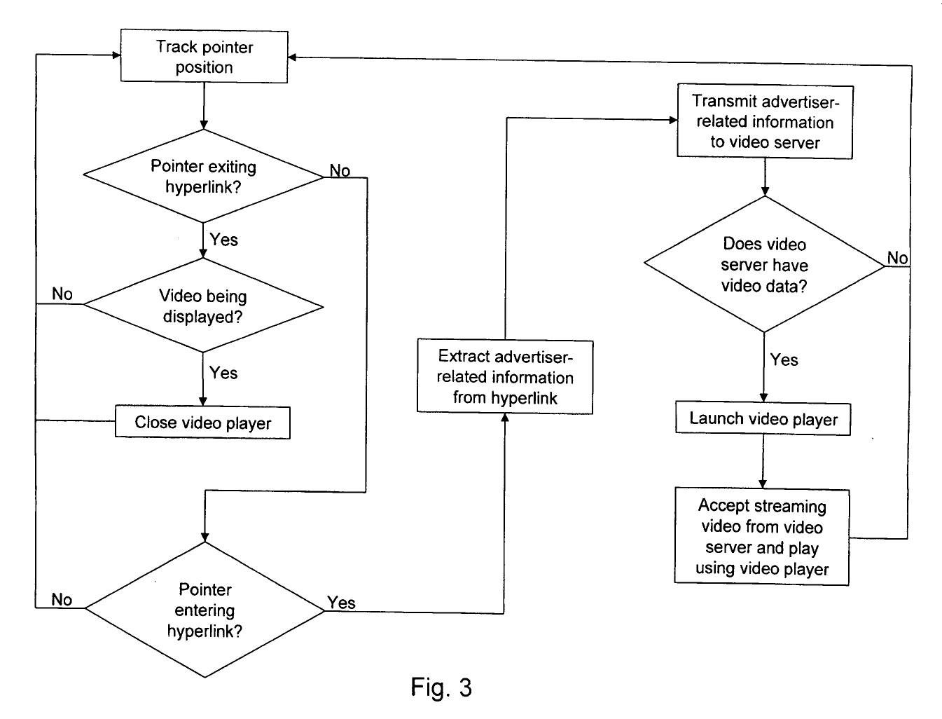

When the client computer 20 downloads and processes the webpage file 100, the client computer 20 renders the webpage image 26a on top of the page, and also calls the requisite plug-in 21 to begin executing the embedded tracking code 120. FIG. 3 is a flow-chart for one embodiment of the tracking code 120. Once executing, the tracking code 120 begins monitoring the position of the pointer 23 within the display 22. Each hyperlink 24 covers a respective region of the screen display 22; the pointer 23 may therefore either overlap a specific one of the hyperlinks 24, or not overlap any of the hyperlinks 24. If the pointer 23 goes from a condition of not overlapping a hyperlink 24 to overlapping a hyperlink 24, the pointer 23 may be said to be entering that hyperlink 24, and hence is hovering over the hyperlink 24. Similarly, if the pointer 23 goes from a condition of overlapping a hyperlink 24 to not overlapping the hyperlink 24, the pointer 23 may be said to be exiting that hyperlink 24. The tracking code 120 monitors whether the pointer 23 enters or exits any of the hyperlinks 24. In a preferred embodiment, the video 28 is closed (i.e., made to disappear) when the user moves the pointer 23 away from a hyperlink 24. Hence, in this embodiment, when the tracking code 120 determines that the pointer 23 is exiting a hyperlink 24, the tracking code 120 then determines if the video 28 is being displayed. If the video 28 is displayed, the tracking code shuts down the video player, which closes, and thus removes, the video 28. It will be appreciated, however, that variations are possible. For example, rather than closing the video 28 when the pointer 23 exits a hyperlink 24, the tracking code 120 could continue to let the video 28 play until it finishes. Or, the tracking code 120 may close the video player only when the webpage window 26 is refreshed by a new webpage, in which case new videos 28 may be played in the same video window 28 depending upon the position of the pointer 23.

If tracking code 120 determines that the pointer 23 is entering a hyperlink 24, the tracking code 120 then extracts advertiser-related information 25 from this hyperlink 24 into which the pointer 23 has entered, which may then be termed the active hyperlink 24 for the sake of brevity. In certain preferred embodiments, for example, the tracking code 120 extracts the identification (ID) number of an advertiser from the active hyperlink 24 and uses this ID number as the advertiser-related information 25. In preferred embodiments, every advertiser is assigned an ID number that has several uses relating the advertiser with different options on the webpage 26a. ID numbers are typically assigned by the webpage publisher 10, 30 for each advertiser as part of the publisher's database. Preferred embodiments use this ID number to query for a related video from the video server 40 and play this as a video 28 that floats over the webpage 26a.

In preferred embodiments, the tracking code 120 is pre-programmed to establish a communications connection with the video server 40. For example, the tracking code 120 may be pre-programmed with the URL of the video server 40, or the IP address of the video server 40, as well as the specific protocol that is to be used for communications. The tracking code 120 then transmits to the video server 40, using the appropriate communications protocol, the advertiser-related information 25 extracted from the active hyperlink 24. In preferred embodiments, HyperText Transfer Protocol (HTTP) is used in this initial query between the user computer 20 and the video server 40 to determine if a related video is available.

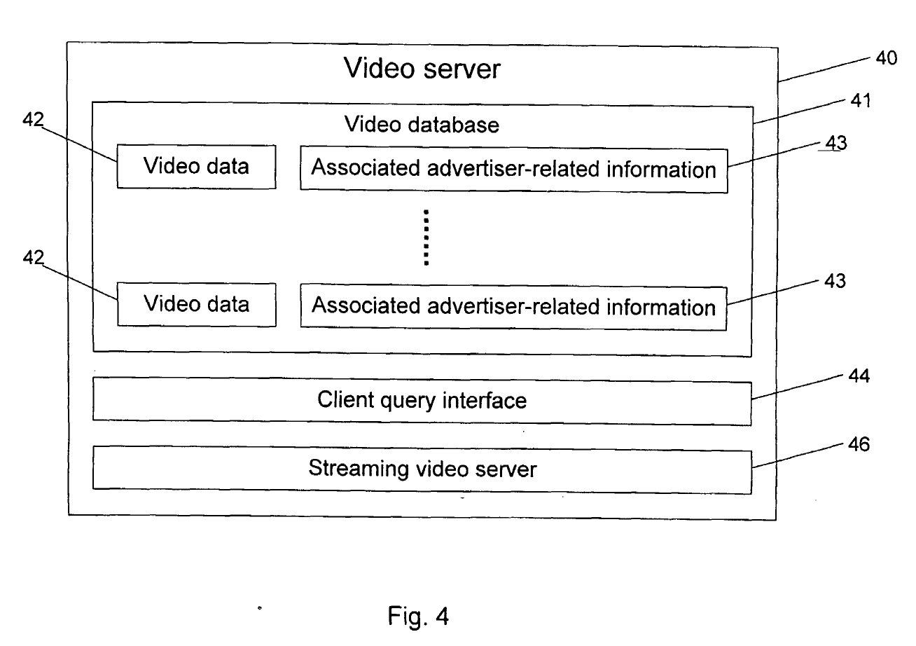

With further reference to FIG. 4, which illustrates an embodiment video server 40, the video server 40 is preferably capable of transmitting several gigabytes in video data per second. Although shown as a single element, it will be appreciated that in practice the video server 40 may be provided by a plurality of computer systems, such as blade servers or the like, working together as the video server 40. The video server 40 includes a client query interface 44 that is used to communicate with the client computer 20 to accept the advertiser-related information 25. The video server 40 continuously listens on the client query interface 44 for video search requests and their associated advertiser-related information 25. The video server 40 then searches a video database 41 for a corresponding video 42. Within the video database 41, each video 42 has associated advertiser-related information 43. The video server 40 parses the associated advertiser-related information 43, looking for a match with the advertiser-related information 25 provided by the client computer 20. The video server 40 then signals back to the client computer 20, via the client query interface 44, information indicating whether or not a match was found in the video database 41. For example, in preferred embodiments if matching video data 42 is found, the video server 40 then sends back information to the client computer 20 for the client computer 20 to play the video data 42 as a video 28. The video server 40 may then begin streaming the video data 42. Preferred embodiments employ Rich Text Messaging Protocol (RTMP) to stream videos 28, and hence open a suitable connection to provide the video data 42 stream. If the RTMP server on the video server 40 is down, the video server 40 may employ another connection, such as an HTTP connection, to stream the video data 42.

On the other hand, if no matching video data 42 is found, the video server 40 may not send any information relating to playing the video 28 and instead may close the connection, which may signal that no related video data 42 is available. In other embodiments, the video server 42 may explicitly signal to the client computer 20 that no matching video data 42 is present. In preferred embodiments, the client computer 20 and the video server 40 also send and receive data based on various events, such as video 28 start, video 28 stop, etc., using the client query interface 44, which may be done using, for example, the HTTP protocol.

If the video server 40 indicates that no match is found, the tracking code 120 simply goes back to monitoring the position of the pointer 23. The tracking code 120 may also optionally save information indicating that the active hyperlink 24 has no associated video data 42, and thus may forgo another video database 41 query if the user should again hover over that same hyperlink 24. Such information may be flushed each time the webpage image 26a is refreshed. However, if the video server 40 indicates that a match was found, the tracking code 120 then calls player launch code 122. The player launch code 122 plays video 28. This video 28 is overlaid on and floats over the original webpage window 26, and hence does not interfere with the contents 26a of the webpage window 26. The video 28 may be positioned over or near the active hyperlink 24 to indicate to the user that the video 28 is associated with the active hyperlink 24. To play the video 28, the player launch code 122 starts a video player program. The video player establishes a connection with the video server 40 to obtain the video data 42 corresponding to the advertiser-related information 25. The video server 40 streams the related video data 42, such as through an RTMP connection, to the client computer 20, and the video player reads this video data 42 to play the corresponding video 28. When the video 28 ends, the player launch code 122 may, depending upon the implementation chosen, close the video player, or may leave and the video player running for the user to again view the video 28, if so desired.

As described above, in preferred embodiments when the pointer 23 exits the active hyperlink 24, the tracking code 120 causes the video player, and hence video 28, to close. Because the video 28 floats over the webpage window 26, the webpage image 26a is not disturbed by either the opening or the closing of the video 28. If the pointer 23 should then hover over another of the hyperlinks 24, the process above will repeat, with a new video 28 playing over or near this newly-active hyperlink 24.

In other embodiments, rather than parsing the hyperlinks 112 in response to the pointer 23 entering a hyperlink 24, the tracking code 120 may instead parse all of the hyperlinks 112 for the related advertiser-related information 25 and send corresponding queries to the video server 40. For example, once the webpage 26 is loaded, the tracking code 120 may immediately begin sending to the video server 40 a plurality of video queries, one for each hyperlink 24. The video server 40 may respond to each of these queries by streaming the related video data 42. However, in such embodiments, the tracking code 120 may then only begin playing this video data 42 as a video 28 when the pointer 23 floats over the corresponding hyperlink 24.

Various embodiments benefit the directory listing website 30 and the search engine websites 10, as well as the advertising companies and the end user 20 that is looking for the right product. The existing directory listings 30 and the search engine 10 can present their web pages 12, 32 in a standard manner, but simply augment them with the tracking code 120 to quickly and easily provide related embedded video advertising. All the advertisers that appear on the listing 32 and search engine 12 web pages look the same (being only of text and hyperlinks 24) and consequently the user mostly chooses to review the offers on the first few websites that are displayed at the top of the list. The various embodiment advertising methods, however, allow the search engine's 10 and directory listing server's 30 advertisers to add a respective special video 42 that plays when the user's mouse hovers over a specific advertiser's hyperlink 24, with no need to click on the hyperlink 24 to play the video 42. The video 28 runs automatically, presenting the special products, offers, and services that are specific and unique for this advertising company. The video 28 may, for example, encourage the user to click on the hyperlink 24 and review the advertising company's website. The added video 28 may therefore promote the advertiser's website even more forcefully than the mere position of the hyperlink 24 in the list of advertisers on the webpage image 26a.

Today, search engines 10 are paid per click by advertisers that bid on the highest position on the list 110 in their category. Using video as part of the advertisers' promotion on the search engine page 12 and directory listings page 32 will create more revenue for the directory listings 30 and the search engine 10, since end users 20 will be more interested in clicking upon the website hyperlink 24 that is promoted by video 28 to view the offers presented by the advertising companies.

Directory listings 30 and search engines 10 websites typically have a section in their respective web pages 32, 12 to display non-paying advertisers. These non-paying advertisers may be termed organic traffic, and the positioning of the organic traffic in the list 110 is generally based upon popularity. The directory listings server 30 and the search engine server 10 lists these advertising companies as a service to the end user 20 without being paid for this service. With the various embodiments, however, non-paying advertisers will be interested in the new and additional service feature, the video presentation of their websites, as a way to entice more users to click on their respective hyperlink 24 and visit their website. The directory listings server 30 and search engine server 10 will thus have a way to charge these advertising companies for the promotional video service.

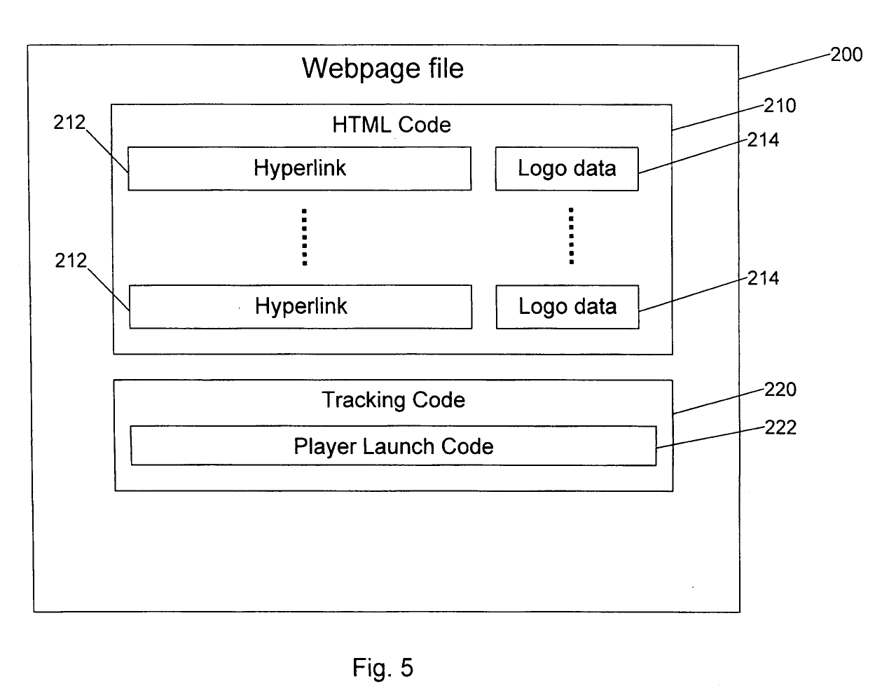

In light of the above, certain embodiments provide for the search engine server 10 or the directory listings server 30 to change the formatting of the hyperlink list 110 to indicate which advertisers in the list 110 have a corresponding video 42. FIG. 5 illustrates an embodiment webpage file 200 representative of an embodiment search results webpage 12 or directory listings webpage 32 as provided by a respective embodiment search engine server 10 or directory listings server 30. While generating the webpage 200, the server 10, 30 may iterate through each hyperlink 212, extracting and supplying the corresponding advertiser-related information to the client query interface 44 of the video server 40. If the video server 40 responds that a corresponding video 42 is present within the video database 41, the server 10, 30 may insert into the scripting code 210 logo data 214 associated with that hyperlink 24; if no video 42 is present, the logo data 214 is omitted for that hyperlink 212.

The logo data 214 causes the web browser 29 to insert a logo 27 or the like next to a corresponding hyperlink 24, thereby informing the user that video data 42 is present for that hyperlink 24 and may be viewed as a video 28 if the user simply hovers the pointer 23 over the hyperlink 24. The webpage file 200 also includes tracking code 220 and player launch code 222 to monitor the pointer 23 and play the appropriate video 42 as described above.

In other embodiments, the tracking code 220 may itself query the video server 40 for each of the hyperlinks 212 to determine if a logo 27 should be placed in the webpage image 26a. The logo 27 therefore need not be part of the scripting code 210. If the video server 40 determines that related video data 42 is available, the video server 40 may provide corresponding logo data to the tracking code 220, and the tracking code 220 may use the logo data to create a logo image 27 on or over the webpage image 26a near the related hyperlink 24.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the following claims.

What is claimed is:

1. A method for delivering videos to a client computer, the method comprising:
transmitting to a client computer a webpage file comprising directory listings or search engine results, the webpage file comprising a plurality of hyperlinks, each hyperlink corresponding to a directory listing entry or a search engine hit;
determining a first video corresponding to a first hyperlink in the plurality of hyperlinks; and
transmitting the first video to the client computer to cause the client computer to play the first video in response to a pointer on the client computer hovering over the first hyperlink.

2. The method of claim 1 further comprising causing the client computer to play the first video overlaid over the webpage so the first video floats over the webpage.

3. The method of claim 1 further comprising:
correlating each of the plurality of hyperlinks with a corresponding advertiser; and
correlating each of a plurality of videos with a corresponding advertiser;
wherein the first hyperlink is correlated with a first advertiser, and the first video is correlated with the first advertiser.

4. The method of claim 3 wherein correlating each of the plurality of hyperlinks with the corresponding advertiser comprises obtaining a name of an advertiser contained in a hyperlink.

5. The method of claim 1 further comprising causing the client computer to stop playing the first video in response to the pointer moving away from the first hyperlink.

6. The method of claim 5 further comprising:
in response to the pointer hovering over a second hyperlink in the plurality of hyperlinks, determining a second video corresponding to the second hyperlink; and
transmitting the second video to the client computer to cause the client computer to play the second video.

7. The method of claim 1 wherein a directory services server or a search engine server transmits the webpage to the client computer.

8. The method of claim 1 further comprising the webpage file causing the client computer to display a logo in relation to each hyperlink that has a corresponding video.

9. The method of claim 1 further comprising embedding an application within the webpage file, the embedded application executable by the client computer to perform the following steps:
monitoring a position of the pointer to determine if the pointer is hovering over a hyperlink;
obtaining advertiser-related information from a hyperlink;
transmitting the advertiser-related information to a video server; and
playing video data obtained from the video server corresponding to a hyperlink over which the pointer is hovering.

10. The method of claim 9 wherein the advertiser-related information is obtained from a hyperlink in response to the pointer hovering over the hyperlink.

11. A method for delivering videos to a client computer, the method comprising:
transmitting to a client computer a webpage file comprising directory listings or search engine results, the webpage file comprising a plurality of hyperlinks, each hyperlink corresponding to a directory listing entry or a search engine hit;
obtaining advertiser-related information from each of the plurality of hyperlinks;
utilizing the advertiser-related information to determine a corresponding plurality of videos;
transmitting the corresponding plurality of videos to the client computer; and
in response to a pointer on the client computer hovering over a first hyperlink in the plurality of hyperlinks, playing a first video in the plurality of videos that corresponds to the first hyperlink.

12. A system for delivering advertising videos to a client computer, the system comprising:
a video server comprising:
a video database comprising a plurality of videos, each video correlated with corresponding advertiser-related information;
a query interface for accepting advertiser-related information from a querying computer and informing the querying computer if a corresponding video is present in the video database; and
a video server for providing a video in the video database to the querying computer; and
a server for providing a webpage file to the client computer, the webpage comprising a plurality of hyperlinks, each hyperlink corresponding to a directory listing entry or a search engine hit, the webpage file further comprising tracking code executable by the client computer for performing the following steps:
monitoring a position of a pointer on the client computer to determine if the pointer is hovering over a hyperlink;
obtaining advertiser-related information corresponding to a hyperlink over which the pointer is hovering;
transmitting the advertiser-related information to the video server; and
playing video data obtained from the video server.
